(19) United States
(12) Patent Application Publication
(10) Pub. No.: US 2012/0123821 A1
(43) Pub. Date: May 17, 2012

(54) System and Method for Risk Assessment of an Asserted Identity

(75) Inventor: Dale M. Rickman, Kensington, MD (US)

(73) Assignee: RAYTHEON COMPANY, Waltham, MA (US)

(21) Appl. No.: 12/947,437

(22) Filed: Nov. 16, 2010

(51) Int. Cl. G06Q 10/00

(52) U.S. Cl. 705/7.28

(57) ABSTRACT

A system for providing a risk assessment for an asserted identity comprising an identity database, a first risk database, a second risk database, an identity module that receives the asserted identity and searches the identity database to retrieve one or more known identities and calculates a probability score for each retrieved known identity, a correlator module that receives each retrieved known identity and respective probability score from the identity module, the correlator module further comprising an identity risk sub-module that searches the first and the second risk databases to retrieve respective first and second risk scores for each known identity, and an assessment module that receives the probability score and the first and second risk scores associated with each of the known identities from the correlator module and calculates a final risk score therefrom to thereby provide a risk assessment for the asserted identity.

### TECHNICAL FIELD OF THE DISCLOSURE

This disclosure relates generally to identity assessment. More particularly, this disclosure relates to a system and method for assessing the risk associated with an asserted identity.

### BACKGROUND OF THE DISCLOSURE

The need to assess the certainty and the risks associated with an asserted identity is becoming ever-increasing in today's world. With more and more issues arising daily regarding access control, border patrol, traveler processing and credit worthiness, the need for more improved means for quickly and accurately evaluating and determining the risks associated with granting certain privileges and entitlements to a particular person is of the utmost importance. In general, the current systems in place today for achieving such risk evaluations typically involve manual processes. In particular, groups or individuals responsible for assessing risks associated with asserted identities are forced to make a best guess as to which person they are actually dealing with.

Currently, watchlist matching is one of the most prevalent forms of risk assessment performed today. However, it is not quantitative and the consequences of granting the entitlement to a given individual are not well defined. Another form of risk assessment occasionally used today is behavioral profiling. However, it is typically not combined with a person risk assessment or any other risk assessment to create a combined assessment in the form of a single risk score for the asserted identity.

In general, the forms of risk assessment for asserted identities currently being utilized today are predominantly manual, time intensive processes providing very questionable results that ultimately require a human's best guess on risk. The lack of the current systems to provide a consistent quantitative risk assessment of asserted identities leaves us with a very unreliable and otherwise hit-or-miss system. As the importance of risk assessment becomes ever-so-high in the overall role of homeland defense and the security of territorial borders, the current systems are simply unacceptable.

More particularly, the risk assessment systems in use today have been designed to evaluate one aspect or dimension of a person, like, for example, a person's name, a particular behavior, a particular request to do something or a particular environmental state of awareness. However, generally only one of such dimensions is looked at by any one particular system and the final assessment still relies heavily on the human to make the final decision. This one dimensional approach, as well as manual nature, has in effect rendered current systems obsolete for tackling the challenges of today's complex world. Hence, there are many inadequacies associated with the risk assessment systems and methods being employed today that must be overcome.

Accordingly, there exists a long felt need for an improved system and method for providing risk assessment of an asserted identity that alleviates the inherent problems present in the risk assessment systems currently employed today in the access control industry; and which provides for a quick, consistent, multi-dimensional and reliable risk assessment for an asserted identity.

### SUMMARY OF THE DISCLOSURE

According to one embodiment of the present disclosure, a system for providing a risk assessment of an asserted identity is presented comprising an identity database, a first risk database, a second risk database, an identity module, a correlator module and an assessment module. The identity module receives the asserted identity and searches the identity database to retrieve one or more known identities and calculates a probability score for each retrieved known identity. The correlator module receives each retrieved known identity and their respective probability scores from the identity module and performs further analysis on the retrieved known identities. The correlator module further comprises an identity risk sub-module that searches the first and the second risk databases to retrieve respective first and second risk scores for each known identity. The assessment module is then operable to receive from the correlator module the probability score and the first and second risk scores associated with each of the known identities and calculate a final risk score thereby providing a risk assessment of the asserted identity.

In one embodiment of the present disclosure, the correlator module may employ a watchlist database and an identity history database to provide the respective first and second risk scores for each known identity. This provides one form of multi-dimensional risk assessment for known identities having a probability of being the same person as the asserted identity. The assessment module will then process all the risk scores for each known identity along with the probabilities for each known identity to calculate a single overall final risk score for the asserted identity.

Accordingly, some embodiments of the disclosure may provide numerous technical advantages. Some embodiments may benefit from some, none or all of these advantages. For example, a technical advantage of one embodiment of the disclosure may be an improved faster system and method for the risk assessment of an asserted identity that alleviates the need for any human manual processing of a final risk score. Furthermore, such a system and method may provide for a more consistent and reliable risk assessment of an asserted identity. Another embodiment may provide for a more multi-dimensional risk assessment of an asserted identity that takes advantage of behavior information to achieve an even more multi-dimensional final risk score. Still further, this enhanced multi-dimensional risk assessment of an asserted identity may provide the ability to detect risks that may otherwise not have been detected for an asserted identity if only one or two other dimensions were evaluated.

Another example of a potential technical advantage of one embodiment of the present disclosure is that it may provide for the ability to flexibly and dynamically allow for the final risk score calculation to take into account the desired entitlement of the asserted identity or a particular environmental factor existing at the time of the asserted identity. Current systems simply do not provide for any means of adjustment in consistent and reliable risk assessments.

Another example of a potential technical advantage of one embodiment of the present disclosure is that one single risk score is provided to represent an overall risk assessment for an asserted identity. Having a single risk score that is multi-dimensional based can provide a significant improvement to tools used in access control, border patrol, travel processing and/or credit worthiness assessments.

Although specific advantages have been disclosed hereinabove, it will be understood that various embodiments may include all, some, or none of the disclosed advantages. Additionally, other technical advantages not specifically cited may become apparent to one of ordinary skill in the art following review of the ensuing drawings and their associated detailed description. The foregoing has outlined rather broadly some of the more pertinent and important advantages of the present disclosure in order that the detailed description of the disclosure that follows may be better understood so that the present contribution to the art can be more fully appreciated. It should be appreciated by those skilled in the art that the conception and the specific embodiment disclosed may be readily utilized as a basis for modifying or designing other structures for carrying out the same purposes of the present disclosure. It should also be realized by those skilled in the art that such equivalent constructions do not depart from the spirit and scope of the present disclosure as set forth in the appended claims.

### BRIEF DESCRIPTION OF THE DRAWINGS

For a fuller understanding of the nature and possible advantages of the present disclosure, reference should be had to the following detailed description taken in connection with the accompanying drawings in which:

FIG. 1 is a block diagram illustrating the various components of one embodiment of a system for providing a risk assessment for an asserted identity in accordance with the teachings of the present disclosure;

FIG. 2 is a detailed block diagram illustrating the functional modules and the operational flow within the system of FIG. 1 in accordance with the teachings of the present disclosure;

FIG. 3 is a flowchart showing one embodiment of a series of steps that may be performed by the identity module within the system illustrated in FIG. 2 in accordance with the teachings of the present disclosure;

FIG. 4 is a flowchart showing one embodiment of a series of steps that may be performed by the correlator module within the system illustrated in FIG. 2 in accordance with the teachings of the present disclosure;

FIG. 5 is a flowchart showing one embodiment of a series of steps that may be performed by the identity risk sub-module within the system illustrated in FIG. 2 in accordance with the teachings of the present disclosure;

FIG. 6 is a flowchart showing one embodiment of a series of steps that may be performed by the pattern risk sub-module within the system illustrated in FIG. 2 in accordance with the teachings of the present disclosure;

FIG. 7 is a flowchart showing one embodiment of a series of steps that may be performed by the physiological risk sub-module within the system illustrated in FIG. 2 in accordance with the teachings of the present disclosure;

FIG. 8 is a flowchart showing one embodiment of a series of steps that may be performed by the psychological risk sub-module within the system illustrated in FIG. 2 in accordance with the teachings of the present disclosure; and

FIG. 9 is a flowchart showing one embodiment of a series of steps that may be performed by the assessment module within the system illustrated in FIG. 2 in accordance with the teachings of the present disclosure.

Similar reference characters refer to similar parts throughout the several views of the drawings.

### DETAILED DESCRIPTION OF THE EXAMPLE EMBODIMENTS

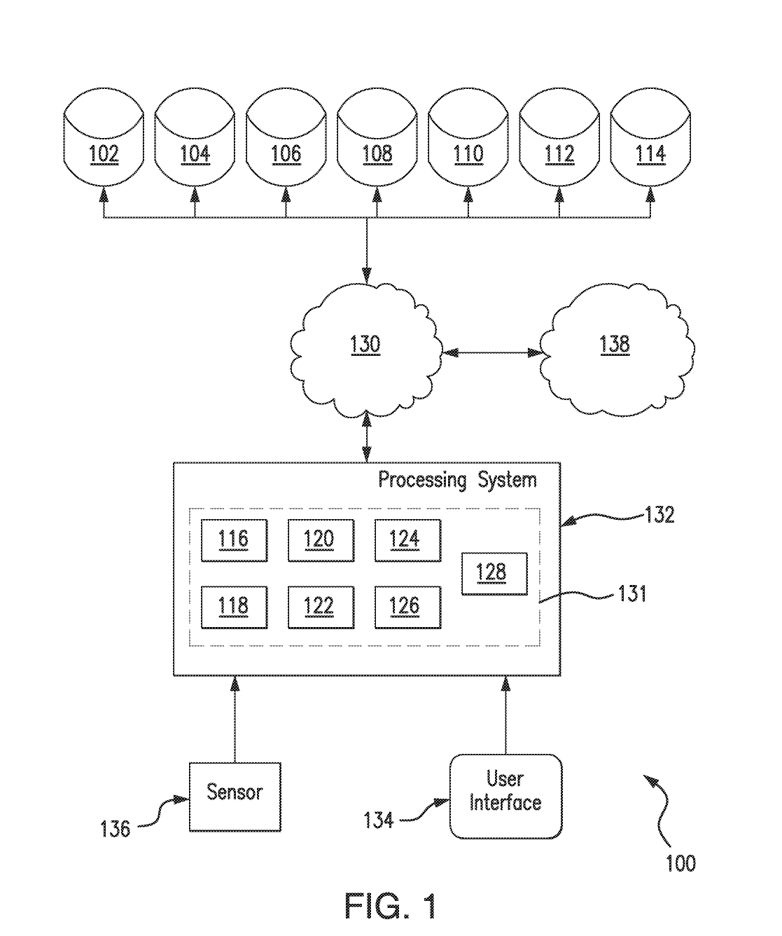

Referring to FIG. 1, a block diagram can be seen illustrating at a high level the various components of one exemplary embodiment of a system 100 for providing a risk assessment of an asserted identity in accordance with the teachings of the present disclosure. In the particular embodiment of FIG. 1, system 100 is comprised of a plurality of databases (namely, an identity database 102, a first risk database 104, a second risk database 106, a pattern risk database 108, a rules database 110, an entitlement risk database 112 and an environmental factor database 114) in communication with and accessible by a plurality of modules (namely, an identity module 116, a correlator module 118, an identity risk sub-module 120, a pattern risk sub-module 122, a physiological risk sub-module 124, a psychological risk sub-module 126, and an assessment module 128) via a communication path 130.

In the particular embodiment of FIG. 1, the modules 116-128 are generally implemented in the form of one or more software modules residing in memory 131 associated with a processing system 132. The modules 116-128 can be written as a software program in any appropriate computer language, such as, for example, C, C++, C#, Java, Assembler, Tcl, Lisp, Javascript, or any other suitable language known in the software industry. The processing system may be any suitable type of computing system implemented with a processor capable of executing computer program instructions stored in a memory, which can include a personal computer, a workstation, a network computer, or any other suitable processing device. The memory may be implemented in the form of any memory for reading data from and writing data to and may include any one or combination of memory elements, such as random access memory (RAM), hard drive, tape, compact disc read/write (CD-RW), disk, diskette, cartridge, or the like resident in or associated with the processing system 132. However, in alternative embodiments, it should be understood that each of modules 116-128 may be separately implemented in the form of a software module residing in the memory associated with an individual standalone processing system with each operable to access the databases 102-114 via the communication path 130. The communication path 130 is preferably implemented in the form of a computer network.

The databases 102-114, in the particular embodiment of FIG. 1, are generally implemented in the form of individual database files residing in the memory associated with standalone processing systems. More particularly, the databases 102-114 may be implemented in the form of a plurality of individual processing systems, each having associated memory and a database file resident therein such as, for example, a plurality of individual database servers forming a distributed database system. Alternatively, in another embodiment, databases 102-114 may be implemented in the form of a plurality of database files residing in the memory associated with a single standalone processing system. Still further, in another embodiment, databases 102-114 may be implemented in the form of individual database files residing in the same memory associated with the one or more processing systems where modules 116-128 reside and wherein the communication path 130 may be implemented in the form of a bus configured within the one or more processing systems.

The processing system 132, in the embodiment of FIG. 1, preferably further includes a user interface 134 and one or more sensors 136 coupled thereto. User interface 134 may be implemented in the form of a display, such as a cathode ray tube (CRT) or liquid crystal display (LCD) screen, and any one or more input devices, such as a keyboard, touchpad, touch screen, a pointing device, a mouse or a joystick providing for interactive control of the processing system 132. Sensors 136 may be implemented in the form of any one or more suitable types of sensors configured to detect and/or measure physiological aspects of an individual, such as, for example, infrared sensors for detecting temperature, sweating or labored breathing of an individual. Sensors 136 may also include any one or more suitable types of sensors configured to detect and/or measure psychological aspects of an individual, such as, for example, high speed cameras to detect micro-expressions, eye trackers to detect eye movement or heart rate sensors that all might indicate an individuals' state of mind, such as deception or hostile intent.

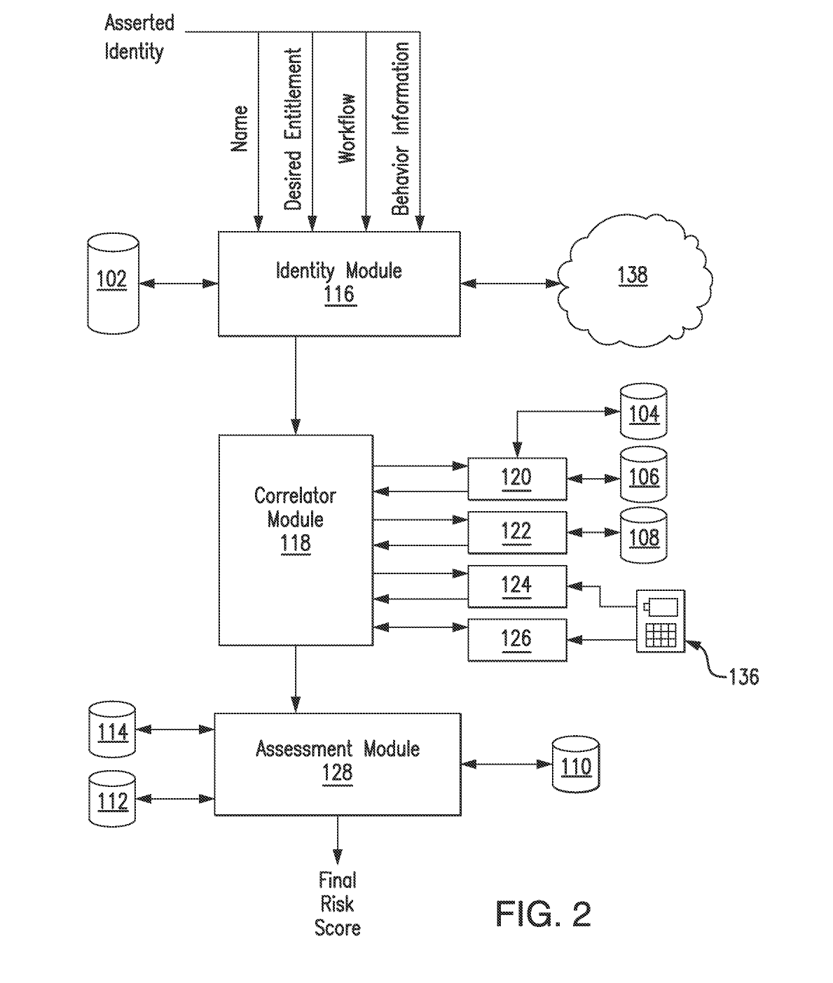

In the embodiment of FIG. 1, system 100 further includes access to open source data 138. Open source data 138 may be in the form of data readily available on the internet free to the public or available through paid subscription. Now that the individual components of system 100 have been described with regard to the particular embodiment of FIG. 1, the interoperability of the modules 116-128 with the databases 102-114 may be more fully understood by now referring to FIG. 2.

In referring now to FIG. 2, a detailed block diagram is provided illustrating the operational flow of communication among the modules 116-128 and the databases 102-114 within the system 100 of FIG. 1 in accordance with the teachings of the present disclosure. The identity module 116 is coupled to and operable to perform searches in the identity database 102 as well as coupled to and operable to perform searches in the open source data 138. The identity database 102, in one embodiment, is preferably comprised of known identities arranged in a searchable manner. However, it should be understood that, other various information may be included in the identity database 102 such as, for example, a physical description, a last known address, or other information of the like pertaining to a specific known identity. From the results of the searching, identity module 116 communicates with the correlator module 118 to pass on information to it for further processing. The correlator module 118 is preferably operable to receive, as part of the information received from the identity module 116, an assigned workflow.

The assigned workflow serves to dictate how the further processing is to occur within system 100 of FIG. 1. For example, in one embodiment, the assigned workflow may be in the form of a template that dictates which of the databases 104-114 are to be searched and how assessment module 128 is to calculate the final risk score for the particular risk assessment at hand. The templates may be implemented so as to dictate not only which modules 120-126 to call but also in what order by defining such in the template itself or by publishing such using service oriented architecture (SOA) technology. However, it should be understood that any number of varying templates may be created and otherwise customized as appropriate for a particular application. The correlator module 118, in one embodiment, may be implemented in the form of an interpreter that reads simple text file templates. Alternatively, in other embodiments, the correlator module 118 may be implemented in the form of a rules engine that uses workflow rules based templates or in some other form suitable for carrying out the intended functionality.

It should be understood that one or more templates may apply based on the asserted identity. For example, if the scenario is assessing risk for people entering the country, the desired entitlement may comprise a request for a student visa. For this, however, there may be a number of templates that apply to a request for a student visa, such as one for each specific country the individual is coming from. In this case, an individual coming from one country may require a less rigorous assessment (e.g., search only watchlist database) than an individual coming from another country (e.g., search multiple or all databases 102-114).

The correlator module 118 is further operably coupled to each of the identity risk sub-module 120, the pattern risk sub-module 122, the physiological risk sub-module 124, the psychological risk sub-module 126, and an assessment module 128. The correlator module 118 communicates with the identity risk sub-module 120 to coordinate searching the first risk database 104 and the second risk database 106 to retrieve respective first and second risk scores based on the information received from the identity module 116. The identity risk sub-module 120 will return the first and second risk scores to the correlator module 118.

In one embodiment, the first database 104 may preferably comprise a watchlist database arranged in a searchable relational manner with watchlist names each having a watchlist risk score, and the second database 106 may preferably comprise an identity history database arranged in a relational manner with identity names each having a history risk score. For example, a known identity listed in the identity history database may have a high history risk score based on the fact that in the past when visiting this country they tend to overstay. Alternatively, in another embodiment where system 100 might be used for assessing risks associated with the loaning of money to individuals, a known identity listed in the identity history database might have a high history risk score if they have a past history of making late payments. Still further, it should be understood that a history risk score may be good (i.e., a low history risk score) or bad (i.e., a high history risk score). In one embodiment, the watchlist risk score and the history risk score form the first and second risk scores respectively. Alternatively, in other embodiments, first and second risk databases 104 and 106 may preferably be comprised of various other types of information arranged in a searchable manner and having respective first and second risk scores associated with such.

The correlator module 118 communicates with the pattern risk sub-module 122 to coordinate searching the pattern risk database 108 to retrieve a behavior risk score based on the information received from the identity module 116. The pattern risk database 108 may preferably comprise, in part, a relational arrangement of various behavior descriptions each having a behavior risk score. For example, if assessing risk for individuals entering the country, one such behavior description may be in the form of “individual buying a one-way ticket at the counter with no luggage” and have an associated high behavior risk score. In contrast, another behavior description may be in the form of “individual buying roundtrip ticket a month in advance” and have an associated low behavior risk score. Alternatively, in other embodiments, pattern risk database 108 may be comprised of various other behavior related information arranged in a searchable manner and having respective behavior risk scores associated with such. The pattern risk sub-module 122 will return a behavior risk score to the correlator module 118.

The correlator module 118 communicates with the physiological risk sub-module 124 to coordinate requesting a health risk score. The physiological risk sub-module 124 is further in communication with one or more sensors 136 to request a scan or the sensing of the individual asserting an identity to detect any health risk indicators. The physiological risk sub-module 124 may preferably comprise, in part, a searchable relational arrangement of various health indicators each having a health risk score. For example, one such health indicator may be in the form of “high body temperature” and having an associated high health risk score, or “sweating” and have an associated high health risk score, or “labored breathing” and having an associated high health risk score. It should be understood that any number of varying health indicators may be created and otherwise customized as appropriate for a particular application. Based on the health risk indicators detected, the physiological risk sub-module 124 returns a health risk score to the correlator module 118.

The correlator module 118 communicates with the psychological risk sub-module 126 to coordinate requesting an intent risk score. The psychological risk sub-module 126 is further in communication with one or more sensors 136 to request a scan or the sensing of the individual asserting an identity to detect any intent indicators. The psychological risk sub-module 126 may preferably comprise, in part, a searchable relational arrangement of various intent indicators each having an intent risk score that is representative of various degrees of deception or hostile intent. For example, one such intent indicator may be in the form of “lacking eye contact with user” and having an associated high intent risk score, or “irregular facial movement” and have an associated high intent risk score, or “rapid heart beat” and having an associated high intent risk score. It should be understood that any number of various intent indicators may be formed as appropriate for a particular application. Based on the intent indicators detected, the psychological risk sub-module 126 returns an intent risk score to the correlator module 118.

The correlator module 118 ultimately communicates with the assessment module 128 passing to it the information from the identity module 116 along with the various risk scores gathered from modules 120-126 for further processing. The assessment module 128 is in communication with and coordinates searches in the rules database 110, the entitlement risk database 112 and the environmental factor database 114 to retrieve a risk calculation rule, an entitlement scaling factor and an environmental scaling factor respectively. The assessment module 128, in general, further facilitates calculating a final risk score for the asserted identity. The rules database 110 may preferably comprise, in part, a relational arrangement of various risk calculation rules arranged in a searchable manner which govern how the assessment module 128 will calculate the final risk score.

For example, one such risk calculation rule may be in the form of “calculate the final risk score by computing the sum of the risk scores gathered for each known identity and multiply by the respective probability associated with that known identity”. Alternatively, another example may be in the form of “calculate the final risk score by returning the highest of the gathered risk scores for any known identity having a probability greater than twenty percent (20%)”. Still further, another example may be in the form of “calculate the final risk score by returning a stoplight chart based on gathered risk scores by returning a red, yellow or green light for each of the various risk scores gathered”. It should be understood that any number of varying risk calculation rules may be created and otherwise customized as appropriate for a particular application.

The entitlement risk database 112 may preferably comprise, in part, a searchable relational arrangement of various entitlements each having an entitlement scaling factor. For example, in one embodiment for a specific application, one such entitlement may be in the form of “request for multi-engine commercial jet pilot's license” and having an associated high entitlement scaling factor. In contrast, another example of one such entitlement may be in the form of “request for single-engine private plane license” and having an associated low entitlement scaling factor. However, it should be understood that any number of varying entitlements may be created and otherwise customized as appropriate for a particular application.

The environmental factor database 114 may preferably comprise, in part, a searchable relational arrangement of various environmental factors applicable to the particular application at hand with each having an associated environmental scaling factor. For example, in one embodiment, such environmental factors may be in the form of a terrorist alert level, a weekend, a weekday, an off-hour, normal work hour or an intelligence warning, with each of such having an associated environmental scaling factor. However, it should be understood that any number of varying environmental factors may be created and otherwise customized as appropriate for a particular application.

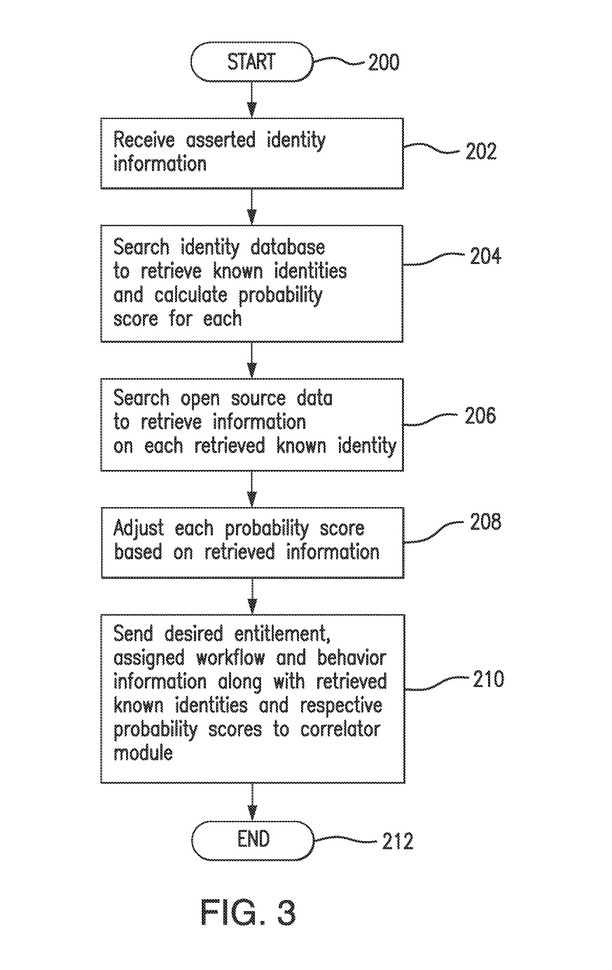

To more fully understand and appreciate the detailed series of steps that may be performed by modules 116-128 during their operation to accomplish the teachings of the present disclosure, reference should now be made to FIGS. 3, 4, 5, 6, 7, 8 and 9. For clarity, their operation will be discussed one at a time. However, in one embodiment, it is to be understood that the series of steps undertaken by one or more modules 116-128 may occur contemporaneously in accordance with the teachings of the present disclosure.

In referring now to FIG. 3, a flow chart can be seen showing the details of one embodiment of a series of steps that may be performed by the identity module 116 in accordance with the teachings of the present disclosure. At step 200, the process is initiated. The process may be initiated by applying power to and performing any suitable bootstrapping operations to system 100. At step 202, the identity module 116 receives the asserted identity information. The asserted identity for an individual to be assessed may preferably be comprised of any one or more of a name, a citizenship, a date of birth, a last known address, a Passport Number, a Drivers License Number, a height, a weight, a hair color, an eye color, a nationality, a desired entitlement, behavior information and an assigned workflow.

However, it should be understood that, depending on the specific requirements of the particular application at hand, the asserted identity may comprise all, some or none of the above aforementioned information. As an example, for risk assessment of individuals in an air travel scenario, the asserted identity may comprise a name, citizenship, date of birth, last known address, a desired entitlement (e.g., fly from Boston to Los Angeles), behavior information (e.g., bought one-way ticket yesterday) and an assigned workflow (e.g., template dictating that all databases 104-114 be searched and that the risk scores be combined taking the average or that one or more particular risk scores be returned to the user). From step 202, the process proceeds to step 204.

At step 204, the identity module 116 searches the identity database 102 to retrieve known identities and calculate a probability score for each. In one embodiment, the search may preferably be performed by way of first creating a list of potential identities using name matching software to generate a plurality of likely names based on the asserted identity and then comparing those likely names to the known identities in the identity database 102. The search will return one or more known identities each with an associated probability score indicative of the closeness of match with the likely names. To the extent the asserted identity included other information additional to a name, such as a date of birth or a last known address for example, such additional information is used to adjust the probability score when comparing the likely names to the known identities in identity database 102. The name matching software may be in the form of any one of a number of commercial-off-the-shelf (COTS) name matching software commonly available in the industry.

Further, one embodiment may implement the creation of an “Unknown” identity to address the case where the asserted identity is not known to system 100 and wherein the probability score therefor is based on the probability of the other known identities retrieved. For example, if none of the likely names are an exact match to any of the known identities in identity database 102 and none of the known identities that are similar to any of the likely names are from the same state as the asserted identity, the “Unknown” identity would have the highest probability score. From step 204, the process proceeds to step 206.

At step 206, the identity module 116 searches the open source data 138 to retrieve information on each retrieved known identity. In one embodiment, the open source data 138 may preferably be in the form of readily available information on the internet. For example, one such search engine may be in the form of the INTELIUS background search tool. However, the search may be performed by way of using any number of readily available search engines to search the internet based on each of the retrieved known identities and retrieve information thereon. From step 206, the procees proceeds to step 208.

At step 208, the identity module 116 adjusts the probability score associated with each known identity based on the retrieved information using the name matching software as described previously above. From step 208, the process proceeds to step 210. At step 210, the identity module 116 sends the desired entitlement, assigned workflow and behavior information along with each of the retrieved known identities and their respective probability scores to the correlator module 118 for further processing. From step 210, the process proceeds to step 212 where the process ends.

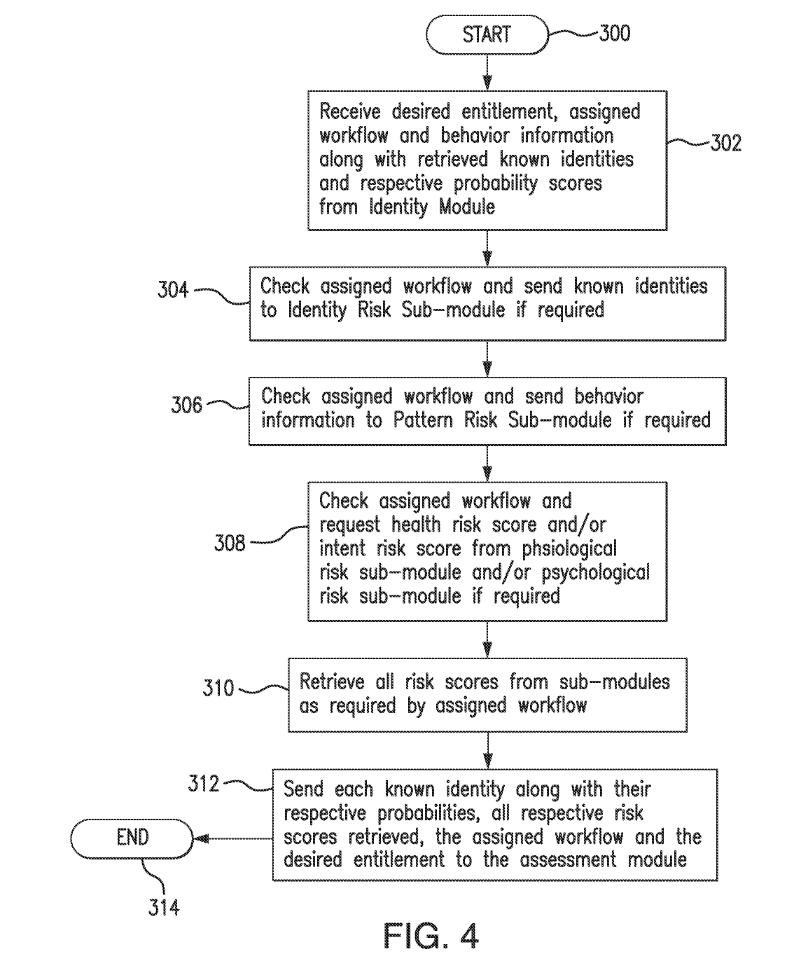

In referring now to FIG. 4, a flow chart can be seen showing the details of one embodiment of a series of steps that may be performed by the correlator module 118 in accordance with the teachings of the present disclosure. At step 300, the process is initiated. The process may be initiated by applying power to and performing any suitable bootstrapping operations to system 100. At step 302, the correlator module 118 receives the desired entitlement, assigned workflow and behavior information along with each of the retrieved known identities and their respective probability scores. From step 302, the process then proceeds to step 304. At step 304, the correlator module 118 checks the assigned workflow and, if required pursuant thereto, sends each of the known identities to the identity risk sub-module 120 and requests a watchlist risk score and/or a history risk score for each. From step 304, the process proceeds to step 306.

At step 306, correlator module 118 checks the assigned workflow and, if required pursuant thereto, sends the behavior information to the pattern risk sub-module 122 and requests a behavior risk score. From step 306, the process then proceeds to step 308. At step 308, the correlator module 118 checks the assigned workflow and, if required pursuant thereto, sends a request to the physiological risk sub-module 124 for a health risk score and/or a request to the psychological risk sub-module 126 for an intent risk score. From step 308, the process proceeds to step 310. At step 310, the correlator module 118 retrieves all risk scores requested from modules 120-126 as required by the assigned workflow. From step 310, the process proceeds to step 312. At step 312, the correlator module 118 sends each of the known identities along with their respective probability scores, all respective risk scores retreived, the assigned workflow and the desired entitlement to the assessment module 128. From step 312, the process proceeds to step 314 where the process ends. It should be understood that the assigned workflow may dictate the order in which the correlator module 118 calls up or otherwise makes its requests to the various modules 120-126 in any number of varying order combinations.

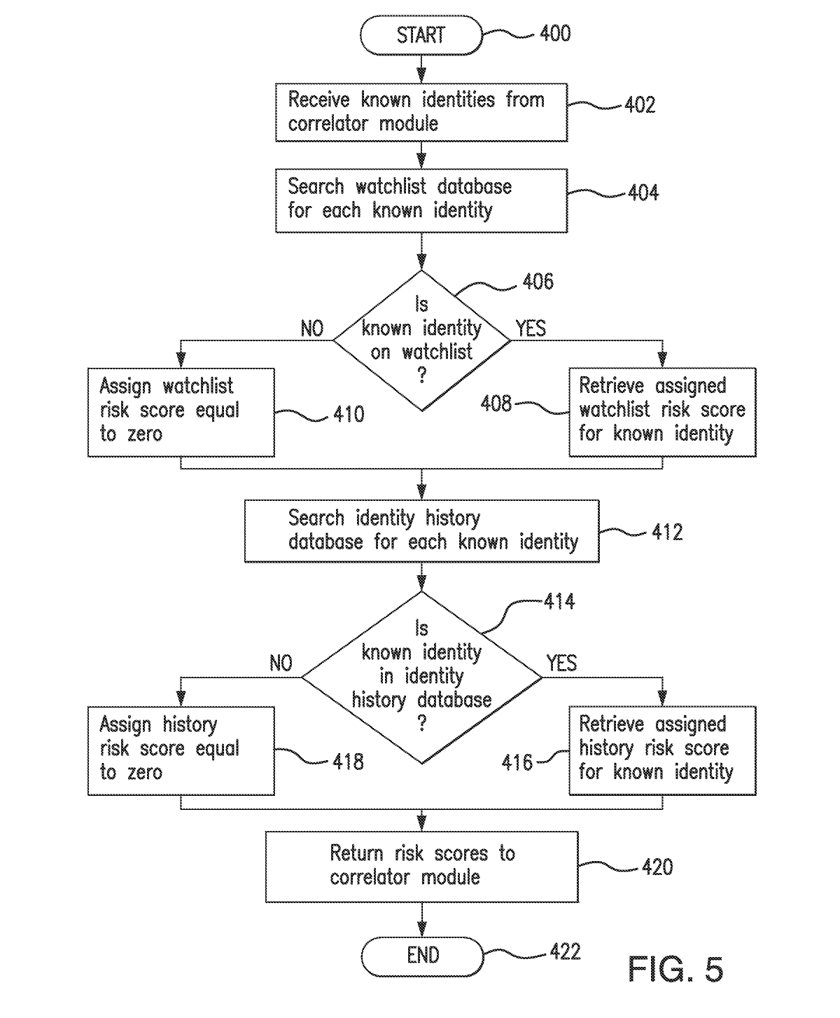

In referring now to FIG. 5, a flow chart can be seen showing the details of one embodiment of a series of steps that may be performed by the identity risk sub-module 120 in accordance with the teachings of the present disclosure. At step 400, the process is initiated. The process may be initiated by applying power to and performing any suitable bootstrapping operations to system 100. At step 402, the identity risk sub-module 120 receives each of the known identities from the correlator module 118. From step 402, the process proceeds to step 404. At step 404, the identity risk sub-module 120 searches the first risk database 104 for each known identity. In one embodiment, the first risk database 104 may be in the form of a watchlist database comprised of watchlist names each having a watchlist score. From step 404, the process proceeds to step 406.

At step 406, the identity risk sub-module 120 determines if each known identity matches any watchlist names. If yes, then the process proceeds to step 408 where the identity risk sub-module 120 retrieves the associated watchlist score for each known identity having a match. From step 408, the process then proceeds to step 412. If, however, it is determined at step 406 that a particular known identity has no match, then the process proceeds to step 410 where the identity risk sub-module 120 assigns a watchlist score of zero to the known identity. From step 410, the process then proceeds to step 412. At step 412, the identity risk sub-module 120 searches the second risk database 106. In one embodiment, the second risk database 106 may be in the form of an identity history database comprised of identity names each having a history risk score. From step 412, the process proceeds to step 414.

At step 414, the identity risk sub-module 120 determines if each known identity matches any identity names. If yes, then the process proceeds to step 416 where the identity risk sub-module 120 retrieves the associated history risk score for each known identity having a match. From step 416, the process then proceeds to step 420. If, however, it is determined at step 414 that a particular known identity has no match, then the process proceeds to step 418 where the identity risk sub-module 120 assigns a history risk score of zero to the known identity. From step 418, the process proceeds to step 420. At step 420, the identity risk sub-module 120 returns all the watchlist risk scores and the history risk scores for each known identity to the correlator module 118. From step 420, the process proceeds to step 422 where the process ends.

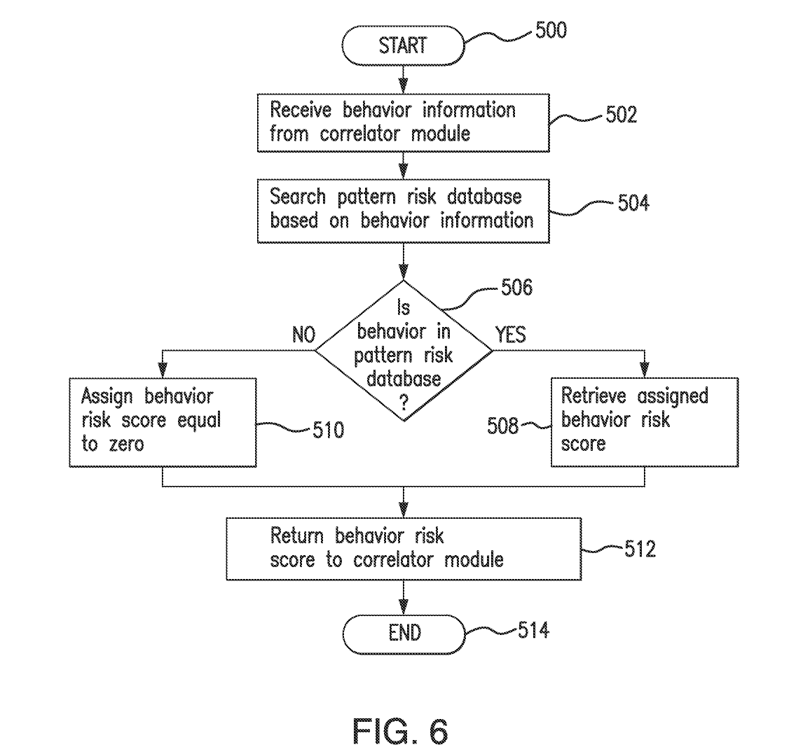

In referring now to FIG. 6, a flow chart can be seen showing the details of one embodiment of a series of steps that may be performed by the pattern risk sub-module 122 in accordance with the teachings of the present disclosure. At step 500, the process is initiated. The process may be initiated by applying power to and performing any suitable bootstrapping operations to system 100. At step 502, the identity risk sub-module 120 receives behavior information from the correlator module 118. From step 502, the process proceeds to step 504. At step 504, the pattern risk sub-module 122 searches the pattern risk database 108 based on the behavior information. From step 504, the process proceeds to step 506.

At step 506, the pattern risk sub-module 122 determines if the behavior information matches any behavior descriptions within the pattern risk database 108. If yes, then the process proceeds to step 508 where the pattern risk sub-module 122 retrieves the behavior risk score associated with the matching behavior description. From step 508, the process then proceeds to step 512. If, however, it is determined at step 506 that the behavior information does not match any behavior description in pattern risk database 108, then the process proceeds to step 510 where the pattern risk sub-module 122 assigns a behavior risk score of zero to the behavior information. From step 510, the process then proceeds to step 512. At step 512, the pattern risk sub-module 122 returns the behavior risk score to the correlator module 118. From step 512, the process proceeds to step 514 where the process ends.

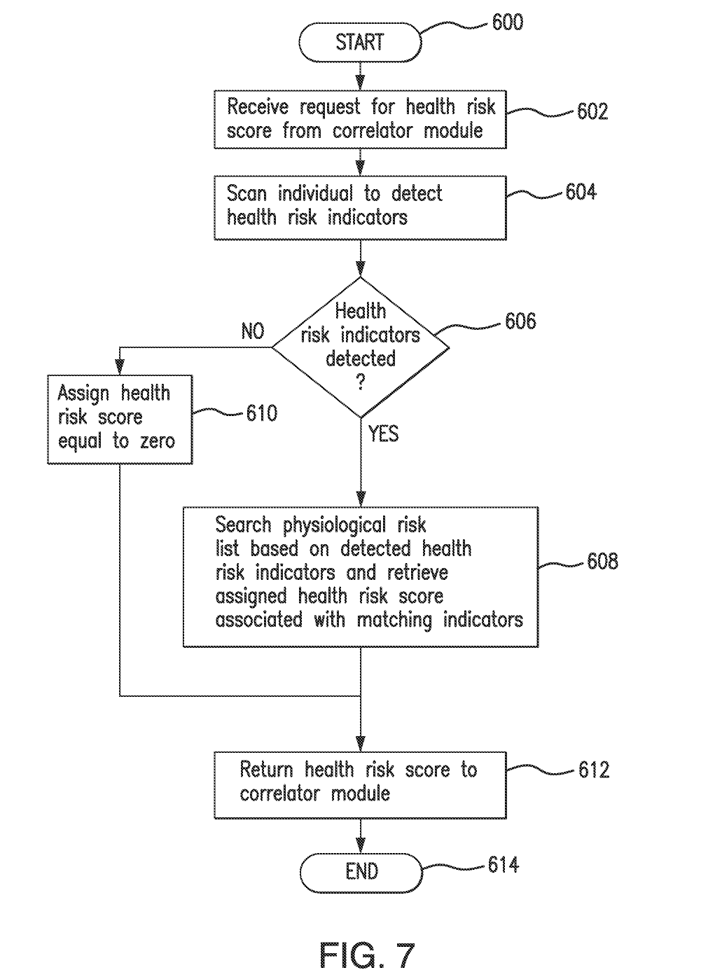

In referring now to FIG. 7, a flow chart can be seen showing the details of one embodiment of a series of steps that may be performed by the physiological risk sub-module 124 in accordance with the teachings of the present disclosure. At step 600, the process is initiated. The process may be initiated by applying power to and performing any suitable bootstrapping operations to system 100. At step 602, the physiological risk sub-module 124 receives a request for a health risk score from the correlator module 118. From step 602, the process proceeds to step 604. At step 604, the physiological risk sub-module 124 requests the sensors 136 to scan or otherwise sense the individual to detect any health risk indicators. From step 604, the process proceeds to step 606.

At step 606, the physiological risk sub-module 124 determines if any health risk indicators were detected. If yes, then the process proceeds to step 608 where the physiological risk sub-module 124 searches a physiological risk list based on the detected health risk indicator(s) and retrieves the health risk score associated with the matching health risk indicator(s). From step 608, the process then proceeds to step 612. If, however, it is determined at step 606 that no health risk indicators were detected, then the process proceeds to step 610 where the physiological risk sub-module 124 assigns a health risk score of zero to the request. From step 610, the process then proceeds to step 612. At step 612, the physiological risk sub-module 124 returns the health risk score to the correlator module 118. From step 612, the process proceeds to step 614 where the process ends.

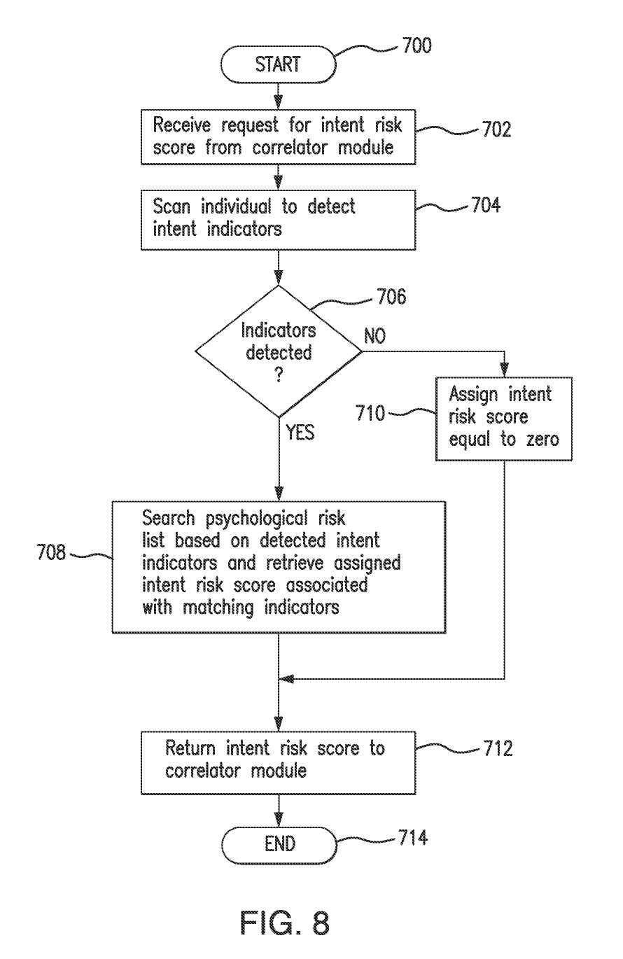

In referring now to FIG. 8, a flow chart can be seen showing the details of one embodiment of a series of steps that may be performed by the psychological risk sub-module 126 in accordance with the teachings of the present disclosure. At step 700, the process is initiated. The process may be initiated by applying power to and performing any suitable bootstrapping operations to system 100. At step 702, the psychological risk sub-module 126 receives a request for an intent risk score from the correlator module 118. From step 702, the process proceeds to step 704. At step 704, the psychological risk sub-module 126 requests the sensors 136 to scan or otherwise sense the individual to detect any intent indicators. From step 704, the process proceeds to step 706.

At step 706, the psychological risk sub-module 126 determines if any intent indicators were detected. If yes, then the process proceeds to step 708 where the psychological risk sub-module 126 searches a psychological risk list based on the detected intent indicator(s) and retrieves the intent risk score associated with the matching intent indicator(s). From step 708, the process then proceeds to step 712. If, however, it is determined at step 706 that no intent indicators were detected, then the process proceeds to step 710 where the psychological risk sub-module 126 assigns an intent risk score of zero to the request. From step 710, the process then proceeds to step 712. At step 712, the psychological risk sub-module 126 returns the intent risk score to the correlator module 118. From step 712, the process proceeds to step 714 where the process ends.

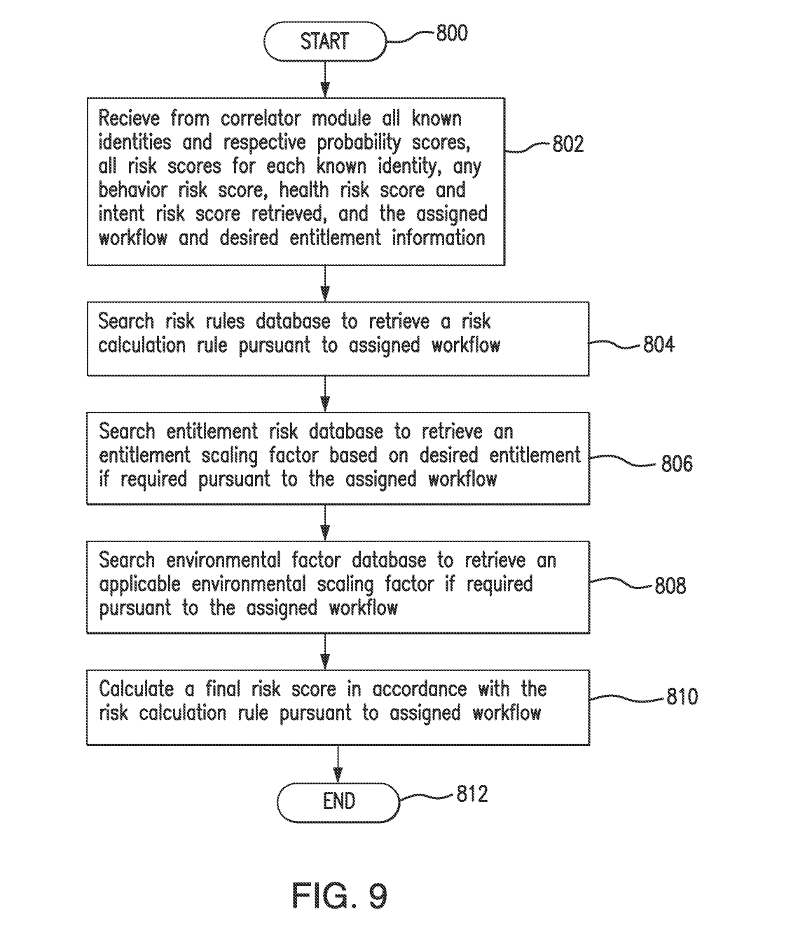

In referring now to FIG. 9, a flow chart can be seen showing the details of one embodiment of a series of steps that may be performed by the assessment module 128 in accordance with the teachings of the present disclosure. At step 800, the process is initiated. The process may be initiated by applying power to and performing any suitable bootstrapping operations to system 100. At step 802, the assessment module 126 receives from the correlator module 118 all known identities and their respective probability scores, all risk scores for each known identity, any behavior risk score, health risk score and intent risk score retrieved, as well as the assigned workflow and the desired entitlement information. From step 802, the process proceeds to step 804. At step 804, the assessment module 128 searches the risk rules database 110 to retrieve a risk calculation rule pursuant to the assigned workflow. From step 804, the process then proceeds to step 806.

At step 806, the assessment module 128 searches the entitlement risk database 112 to retrieve an entitlement scaling factor based on the desired entitlement if required pursuant to the assigned workflow. From step 806, the process proceeds to step 808. At step 808, the assessment module 128 searches the environmental factor database 114 to retrieve an applicable environmental scaling factor if required pursuant to the assigned workflow. From step 808, the process then proceeds to step 810. At step 810, the assessment module 128 calculates a final risk score for the asserted identity in accordance with the risk calculation rule based on the probability scores for each known identity, all risk scores for each known identity, and any health risk score, behavior risk score, and/or intent risk score and adjusts the final risk score based on the entitlement scaling factor and environmental scaling factor pursuant to the assigned workflow. From step 810, the process proceeds to step 812 where the process ends.

The present disclosure includes that contained in the appended claims, as well as that of the foregoing description. Although this disclosure has been described in its preferred form in terms of certain embodiments with a certain degree of particularity, alterations and permutations of these embodiments will be apparent to those skilled in the art. Accordingly, it is understood that the above descriptions of exemplary embodiments does not define or constrain this disclosure, and that the present disclosure of the preferred form has been made only by way of example and that numerous changes, substitutions, and alterations in the details of construction and the combination and arrangement of parts may be resorted to without departing from the spirit and scope of the invention.

What is claimed is:

1. A method for providing a risk assessment for an asserted identity, the method comprising the steps of:
searching an identity database to retrieve one or more known identities based on the asserted identity;
calculating a probability score for each retrieved said known identity;
searching a first risk database to retrieve a first risk score for each said known identity;
searching a second risk database to retrieve a second risk score for each said known identity; and
calculating a final risk score based on said probability score and said first and second risk scores associated with each of said known identities thereby providing a risk assessment for the asserted identity.

2. The method of claim 1, wherein the step of calculating a probability score further comprises the steps of:
searching open source data to retrieve information on each retrieved said known identity; and
adjusting said probability score for each respective said known identity based on the retrieved information.

3. The method of claim 2, wherein said first database is a watchlist database comprised of watchlist names each having a watchlist risk score, and wherein said first risk score is said watchlist risk score.

4. The method of claim 3, wherein said second database is an identity history database comprised of identity names each having a history risk score, and wherein said second risk score is said history risk score.

5. The method of claim 4, further comprising, wherein the asserted identity includes behavior information, the steps of:
searching a pattern risk database to retrieve a behavior risk score based on said behavior information; and
adjusting said final risk score based on said behavior risk score.

6. The method of claim 1, wherein the asserted identity includes a desired entitlement, and wherein the step of calculating a final risk score further comprises the steps of:
searching an entitlement risk database to retrieve an entitlement scaling factor based on said desired entitlement; and
adjusting said final risk score based on said entitlement scaling factor.

7. The method of claim 1, wherein the step of calculating a final risk score further comprises the steps of:
searching an environmental factor database to retrieve an environmental scaling factor; and
adjusting said final risk score based on said environmental scaling factor.

8. A method for providing a risk assessment for an asserted identity, the method comprising the steps of:
searching an identity database to retrieve one or more known identities based on the asserted identity;
searching open source data to retrieve information on each retrieved said known identity;
calculating a probability score for each retrieved said known identity based on the asserted identity and said retrieved information;
searching a first risk database to retrieve a first risk score for each said known identity;
searching a second risk database to retrieve a second risk score for each said known identity; and
calculating a final risk score based on said probability score and said first and second risk scores associated with each of said known identities thereby providing a risk assessment for the asserted identity.

9. The method of claim 8, wherein the asserted identity includes a desired entitlement, and wherein the step of calculating a final risk score further comprises the steps of:
searching an entitlement risk database to retrieve an entitlement scaling factor based on said desired entitlement; and
adjusting said final risk score based on said entitlement scaling factor.

10. The method of claim 9, wherein the step of calculating a final risk score further comprises the steps of:
searching an environmental factor database to retrieve an environmental scaling factor; and
adjusting said final risk score based on said scaling factor.

11. The method of claim 10, wherein said first database is a watchlist database comprised of watchlist names each having a watchlist risk score, and wherein said first risk score is said watchlist risk score.

12. The method of claim 11, wherein said second database is an identity history database comprised of identity names each having a history risk score, and wherein said second risk score is said history risk score.

13. The method of claim 12, wherein the asserted identity includes an assigned workflow, and wherein the step of calculating a final risk score is performed in accordance with a risk calculation rule selected pursuant to said assigned workflow.

14. The method of claim 8, further comprising, wherein the asserted identity includes behavior information, the steps of:
searching a pattern risk database to retrieve a behavior risk score based on said behavior information; and
adjusting said final risk score based on said behavior risk score.

15. A system for providing a risk assessment for an asserted identity comprising:
an identity database;
a first risk database;
a second risk database;
an identity module that receives the asserted identity and searches said identity database to retrieve one or more known identities and calculates a probability score for each retrieved said known identity;
a correlator module that receives each retrieved said known identity and respective probability score from said identity module, said correlator module further comprising:
an identity risk sub-module that searches said first and said second risk databases to retrieve respective first and second risk scores for each said known identity; and
an assessment module that receives said probability score and said first and second risk scores associated with each of said known identities from said correlator module and calculates a final risk score therefrom thereby providing a risk assessment for the asserted identity.

16. The system of claim 15, further comprising an entitlement risk database, and wherein the asserted identity includes a desired entitlement, said assessment module being further operable to search said entitlement risk database to retrieve an entitlement scaling factor based on said desired entitlement and adjust said final risk score based on said entitlement scaling factor.

17. The system of claim 15, further comprising an environmental factor database, and wherein said assessment module is further operable to search said environmental factor database to retrieve an environmental scaling factor and adjust said final risk score based on said environmental scaling factor.

18. The system of claim 15, wherein said first database is a watchlist database comprised of watchlist names each having a watchlist risk score, and wherein said first risk score is said watchlist risk score.

19. The system of claim 18, wherein said second database is an identity history database comprised of identity names each having a history risk score, and wherein said second risk score is said history risk score.

20. The system of claim 15, further comprising a rules database, and wherein the asserted identity includes an assigned workflow, said assessment module being further operable to retrieve a risk calculation rule from said rules database selected pursuant to said assigned workflow and calculate said final risk score in accordance with said risk calculation rule.

21. The system of claim 15, wherein said correlator module further comprises a pattern risk sub-module in communication with a pattern risk database, and wherein the asserted identity includes behavior information, said pattern risk sub-module operable to search said pattern risk database to retrieve a behavior risk score based on said behavior information and adjust said final risk score based on said behavior risk score.
